(19) United States
(12) Patent Application Publication
(10) Pub. No.: US 2025/0139835 A1
(43) Pub. Date: May 1, 2025

(54) A METHOD AND AN APPARATUS FOR ENCODING/DECODING A 3D MESH

(71) Applicant: InterDigital CE Patent Holdings, SAS, Paris (FR)

(72) Inventors: Jean-Eudes Marvie, Betton (FR); Celine Guede, Cesson Sevigne (FR); Maja Krivokuca, Rennes (FR)

(21) Appl. No.: 18/835,413

(22) PCT Filed: Jan. 26, 2023
(86) PCT No.: PCT/EP2023/051939

§ 371 Date: Aug. 2, 2024

(30) Foreign Application Priority Data
Feb. 3, 2022 (EP) 22305117.8

(51) Int. Cl. G06T 9/00; G06T 15/04; G06T 17/20

(52) U.S. Cl. CPC G06T 9/001; G06T 15/04; G06T 17/20

(57) ABSTRACT

Methods and apparatuses for encoding or decoding 3D objects are provided. For at least one face of a mesh representative of a 3D object, the at least one face comprising vertex positions and first texture coordinates associated to the vertex positions in a first texture map, second texture coordinates in a second texture map are obtained from decoded vertices positions of the at least one face and decoded topology of the mesh. A second texture map from the first texture map based on first texture coordinates and on second texture coordinates is obtained and encoded.

### TECHNICAL FIELD

The present embodiments generally relate to a method and an apparatus for encoding and decoding of 3D meshes, and more particularly encoding and decoding of 3D objects represented as meshes.

### BACKGROUND

Free viewpoint video can be implemented by capturing an animated model using a set of physical capture devices (video, infra-red, . . . ) spatially dispatched. The animated sequence that is captured can then be encoded and transmitted to a terminal for being played from any virtual viewpoint with six degrees of freedom (6 dof). Different approaches exist for encoding the animated model. For instance, the animated model can be represented as image/video, point cloud, or textured mesh.

In the Image/Video based approach, a set of video stream plus additional meta-data is stored and a warping or any other reprojection is performed to produce the image from the virtual viewpoint at playback. This solution requires heavy bandwidth and introduces many artefacts. In the point cloud approach, an animated 3D point cloud is reconstructed from the set of input animated images, thus leading to a more compact 3D model representation. The animated point cloud can then be projected on the planes of a volume wrapping the animated point cloud and the projected points (a.k.a. patches) encoded into a set of 2D coded video streams (e.g. using HEVC, AVC, VVC . . . ) for its delivery. However, the nature of the model is very limited in terms of spatial extension and some artefacts can appear, such as holes on the surface for closeup views.

In the textured mesh approach, an animated textured mesh is reconstructed from the set of input animated images. A feature of meshes is that geometry definition can be quite low and photometry texture atlas can be encoded in a standard video stream. Textured meshes encoding relies on texture coordinates (UVs) to perform a mapping of the texture image to the faces/triangles of the mesh.

### SUMMARY

According to an embodiment, a method for encoding at least one 3D object represented using a mesh or encoding at least one 3D mesh is provided, which comprises obtaining, for at least one face of the mesh, the at least one face comprising vertex positions and first texture coordinates associated to the vertex positions in a first texture map, second texture coordinates in a second texture map from decoded vertices positions of the at least one face and decoded topology of the mesh, obtaining a second texture map from the first texture map based on first texture coordinates and on second texture coordinates, and encoding the second texture map.

According to another embodiment, an apparatus for encoding at least one 3D object represented using a mesh or encoding at least one 3D mesh is provided. The apparatus comprises one or more processors configured to obtain, for at least one face of the mesh, the at least one face comprising vertex positions and first texture coordinates associated to the vertex positions in a first texture map, second texture coordinates in a second texture map from decoded vertices positions of the at least one face and decoded topology of the mesh, obtain a second texture map from the first texture map based on first texture coordinates and on second texture coordinates, encode the second texture map.

According to another embodiment, a method for decoding at least one 3D object represented using a mesh or decoding at least one 3D mesh is provided. The method comprises decoding a topology of the mesh, and at least one face of the mesh, the at least one face comprising vertex positions, obtaining texture coordinates for vertices of the at least one face based on the decoded topology and decoded vertex positions.

According to another embodiment, an apparatus for decoding at least one 3D object represented using a mesh or encoding at least one 3D mesh is provided. The apparatus comprises one or more processors configured to decode a topology of the mesh, and at least one face of the mesh, the at least one face comprising vertex positions, obtain texture coordinates for vertices of the at least one face based on the decoded topology and decoded vertex positions.

According to another embodiment, a bitstream comprising coded video data representative of a topology of a mesh, of at least one face of the mesh, the at least one face comprising vertex positions,
coded data representative of an indication indicating a decoder to obtain texture coordinates for vertices of the at least one face based on the decoded topology and decoded vertex positions.

One or more embodiments also provide a computer program comprising instructions which when executed by one or more processors cause the one or more processors to perform any one of the encoding method or decoding method according to any of the embodiments described above. One or more of the present embodiments also provide a computer readable storage medium having stored thereon instructions for encoding or decoding a 3D object according to the methods described herein. One or more embodiments also provide a computer readable storage medium having stored thereon a bitstream generated according to the methods described herein. One or more embodiments also provide a method and apparatus for transmitting or receiving the bitstream generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates an example of a method for encoding a 3D object, according to an embodiment.

FIG. 5 illustrates an example of a method for decoding a 3D object, according to an embodiment.

FIG. 6 illustrates an example of a method for encoding a 3D object, according to another embodiment.

FIG. 7 illustrates an example of a method for decoding a 3D object, according to another embodiment.

FIG. 8 illustrates examples of an original texture map and a reprojected texture map, according to an embodiment.

FIG. 9 illustrates an example of a method for reprojecting the texture map, according to an embodiment.

FIG. 10 illustrates an example of a method for reprojecting a triangle, according to an embodiment.

FIG. 11 an example of a method for fetching source and destination triangles, according to an embodiment.

FIG. 12 illustrates an example of a method for reprojecting a pixel, according to an embodiment.

FIG. 13 shows two remote devices communicating over a communication network in accordance with an example of the present principles.

FIG. 14 shows the syntax of a signal in accordance with an example of the present principles.

FIG. 15 illustrates an embodiment of a method for transmitting a signal according to any one of the embodiments described above.

### DETAILED DESCRIPTION

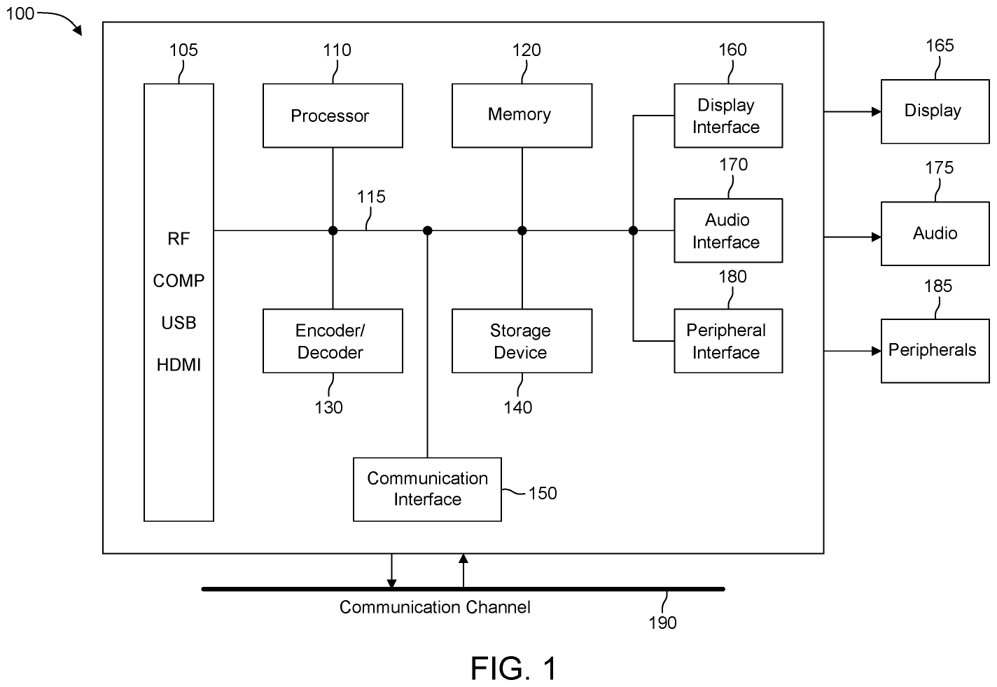

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video/3D object or decoded video/3D object, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video/3D object, the decoded video/3D object or portions of the decoded video/3D object, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for coding and decoding operations, such as for instance MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

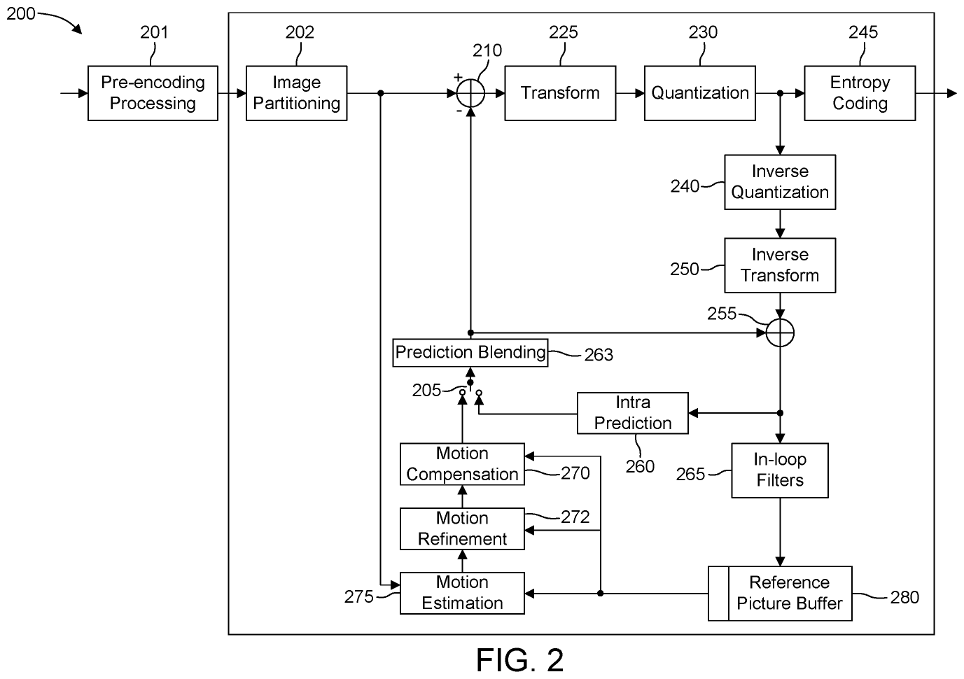

FIG. 2 illustrates an example video encoder 200, such as a High Efficiency Video Coding (HEVC) encoder, that can be used for encoding one or more attributes of an animated mesh according to an embodiment. FIG. 2 may also illustrate an encoder in which improvements are made to the HEVC standard or an encoder employing technologies similar to HEVC, such as a VVC (Versatile Video Coding) encoder under development by JVET (Joint Video Exploration Team).

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods.

Prediction residuals are calculated, for example, by subtracting (210) the predicted block from the original image block. The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

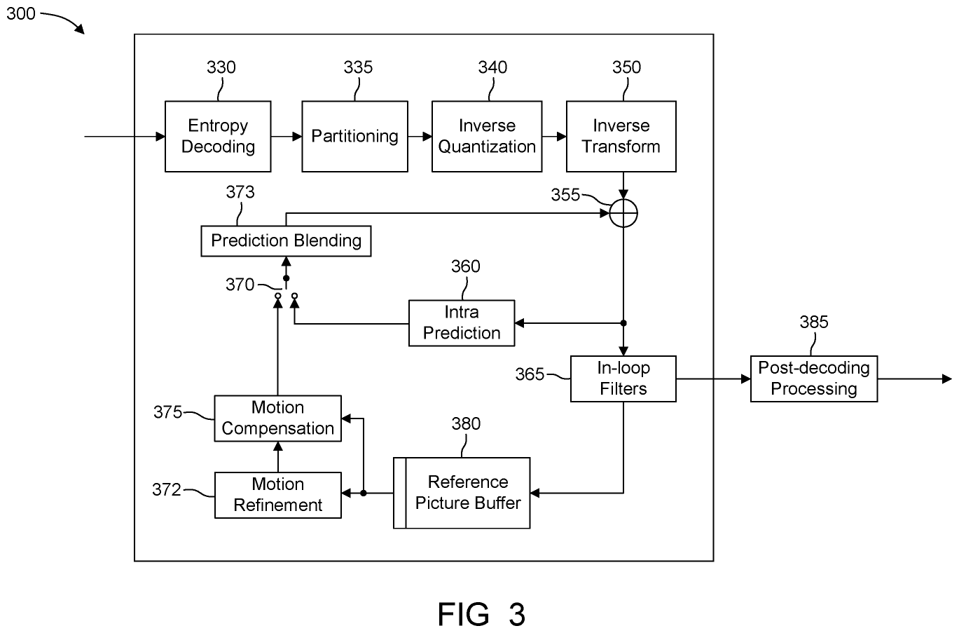

FIG. 3 illustrates a block diagram of an example video decoder 300, that can be used for decoding one or more attributes of an animated mesh according to an embodiment. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

The present application provides various embodiments for encoding/decoding at least one 3D object or an animated 3D object, i.e. a 3D object evolving over time. According to an embodiment, the 3D object is represented as a point cloud or a 3D mesh. The following embodiments are described in the case of a 3D object represented as a 3D mesh. In some variants, the 3D mesh can be derived from a point cloud of the 3D object.

A mesh comprises at least the following features: a list of vertex positions, a topology defining the connection between the vertices, for instance a list of faces, and optionally photometric data, such as texture map or color values associated to vertices. The faces defined by connected vertices can be triangle or any other possible forms. For easiest encoding, the photometric data is often projected on texture map so that the texture map can be encoded as video image.

When coding a mesh with texture maps, one also needs to encode the texture UV coordinates used to map the image texture onto the mesh surface when rendering the textured 3D object.

Storing these UV coordinates can consume a lot of storage space and can be more complex to encode than the vertex positions due to their stronger variability. Therefore, providing a solution that permits to encode the mesh without its UV coordinates but still allows to decode the mesh with UV coordinates is a strong added value for a mesh codec.

According to the principles presented herein, a method for encoding/decoding a 3D object is provided wherein the encoding of texture UV coordinates is avoided when compressing the textured meshes. According to an embodiment, a new texture UV atlas is generated based on the compressed-decompressed version of the mesh and by reprojecting the original texture map to a new texture map using the new UV parameterization. Then, the mesh can be encoded without UV coordinates, but only with the re-projected texture maps plus eventually some metadata in the bitstream. In some embodiments, the metadata can signal an activation of the uv generation, a uv generation mode and some parameters relating to the uv generation mode. During decoding, both the model and the texture map are decoded, the UV coordinates corresponding to the decoded texture atlas are then determined on the decoder side. Thanks to this approach, no texture coordinates need to be encoded in the bitstream. The cost of coding the texture UV coordinates is reduced from its original payload (several megabytes) into very few bytes (e.g. 2 to 16 bytes) for metadata if any.

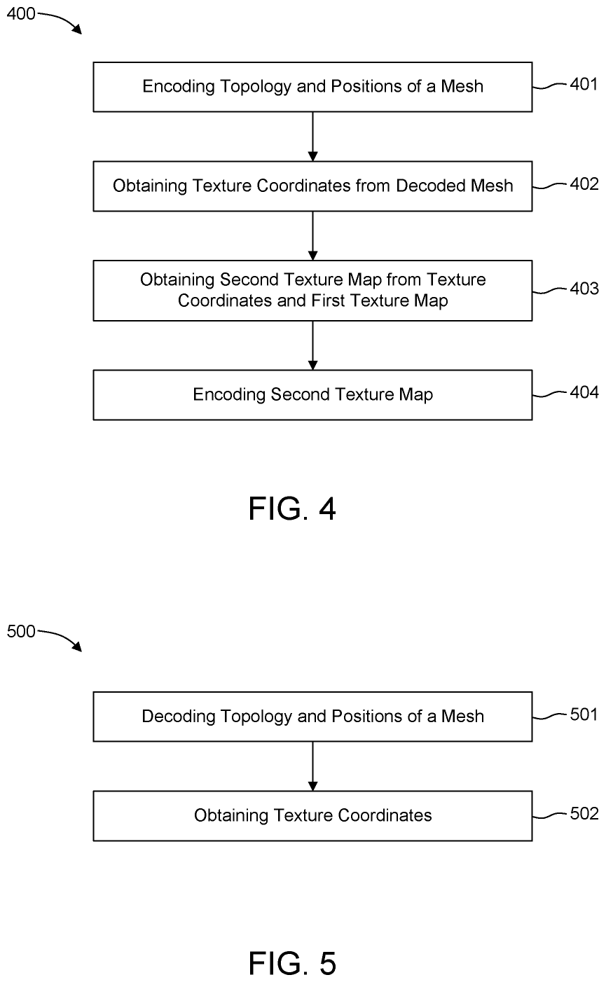

According to an embodiment, a method 400 for encoding a 3D object is described in relation with FIG. 4. The 3D object is represented using a mesh comprising faces defined by vertices, the vertices being connected according to a topology of the mesh. Each vertex of the mesh comprises 3D position (x,y,z) of the vertex and first texture coordinates (u,v) that indicates a location of a texture information in a first texture map for the vertex.

At 401, the topology and vertices positions of the mesh are encoded in a bitstream. At 402, second texture coordinates are obtained for the vertices based on the decoded topology and decoded positions of the mesh. The second texture coordinates indicate a location of a texture information in a second texture map for the vertex to which it is associated. At 03, the second texture map is obtained from the first texture map based on the first texture coordinates and on the second texture coordinates. At 404, the second texture map is encoded in the bitstream.

FIG. 5 illustrates an example of a method 500 for decoding a 3D object, according to an embodiment. The 3D object is decoded from a received bitstream that comprises at least: coded data representative of a topology of a mesh representative of the 3D object, coded data representative of the vertex positions.

At 501, the topology and vertex positions are decoded from the bitstream. At 502, the texture coordinates associated to each vertex are determined based on the decoded topology and decoded vertex positions. The texture coordinates indicate a location of a texture information in a texture map for the vertex to which it is associated. In a variant, the method 500 also comprises decoding the texture map from the bitstream and rendering the 3D object using the texture map and texture coordinates for applying the texture map to the faces of the mesh.

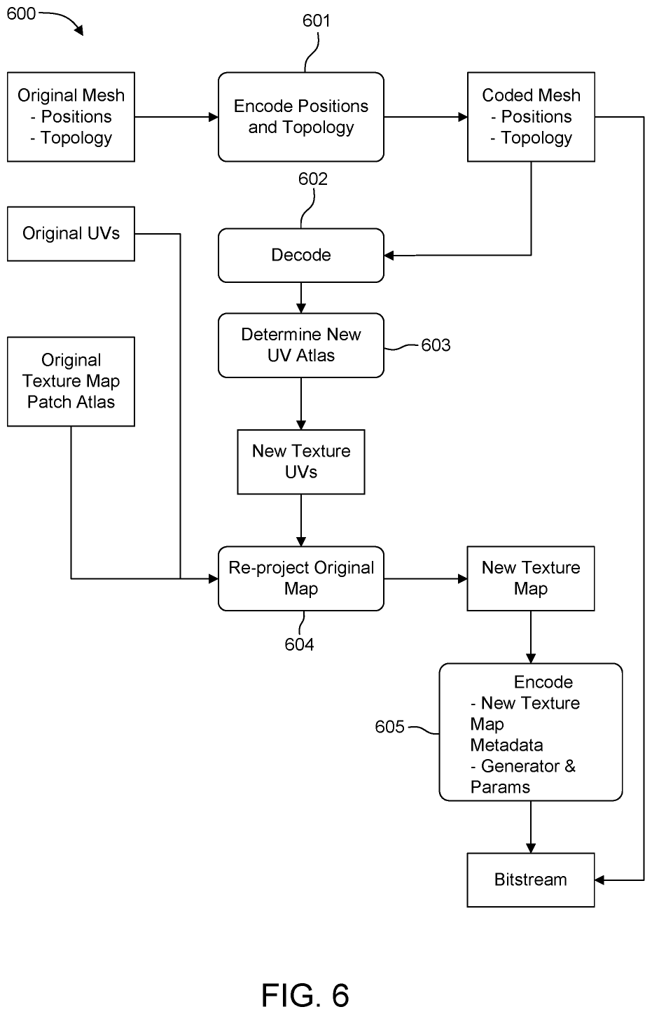

FIG. 6 illustrates an example of a method 600 for encoding a 3D object, according to an embodiment. The 3D object is represented using a mesh comprising faces defined by vertices, the vertices being connected according to a topology of the mesh. Each vertex of the mesh comprises 3D position (x,y,z) of the vertex and first texture coordinates (original U,V) that indicates for the vertex a location of a texture information in a first texture map (original texture map patch atlas). It is assumed here, that the original mesh UV atlas generator is NOT known. In other words, to be as generic as possible, it is assumed that the method used for obtaining the first texture coordinates associated to the vertices of the mesh is not known.

At 601, the positions of the vertices and the topology of the mesh are encoded. The topology is losslessly encoded, while the vertices positions can be lossless or lossy coded. Any method for encoding the topology and vertices positions can be used. For instance, an EdgeBreaker algorithm as defined in J. Rossignac, “3D compression made simple: Edgebreaker with ZipandWrap on a corner-table,” in Proceedings International Conference on Shape Modeling and Applications, Genova, Italy, 2001, can be used. The original UVs are not encoded. The coded topology and positions are added in a bitstream. At 602, the coded topology and coded positions are decoded. At 603, a new UV atlas (i.e. a set of UV coordinates) is determined from the decoded mesh (topology and positions). The new UV atlas can be determined using any UV atlas generator.

For instance, some methods that can be used for generating a UV atlas are defined in [1]: Microsoft UV atlas. https://github.com/microsoft/UVAtlas, [2]: 2018—OptCuts—joint optimization of surface cuts and parameterization. Minchen Li and Danny M. Kaufman and Vladimir G. Kim and Justin Solomon 0001 and Alla Sheffer. ACM Trans. Graph., 247:1-247:13, or [3]: 2002—Least squares conformal maps for automatic texture atlas generation. Bruno Lévy and Sylvain Petitjean and Nicolas Ray and Jérôme Maillot. ACM Trans. Graph., 362-371. These are only examples, other methods for the UV atlas generation can also be used.

In some variants, the choice of the method for generating the new UV atlas depends on a trade-off between computation complexity and atlas quality. New texture UVs are thus obtained for the decoded topology and positions. At 604, the original texture map is re-projected from the original UV atlas (first texture coordinates) to the new UV atlas (second texture coordinates) so as to obtain a new texture map. At 605, the new texture map is then encoded in the bitstream. In some variants, when several methods for generating the UV atlas are possible at the decoder, some metadata are also encoded to signal which UV atlas generation method is used and any needed parameters of the method, so that the decoder can generate the UV atlas in a same manner as on the encoder side.

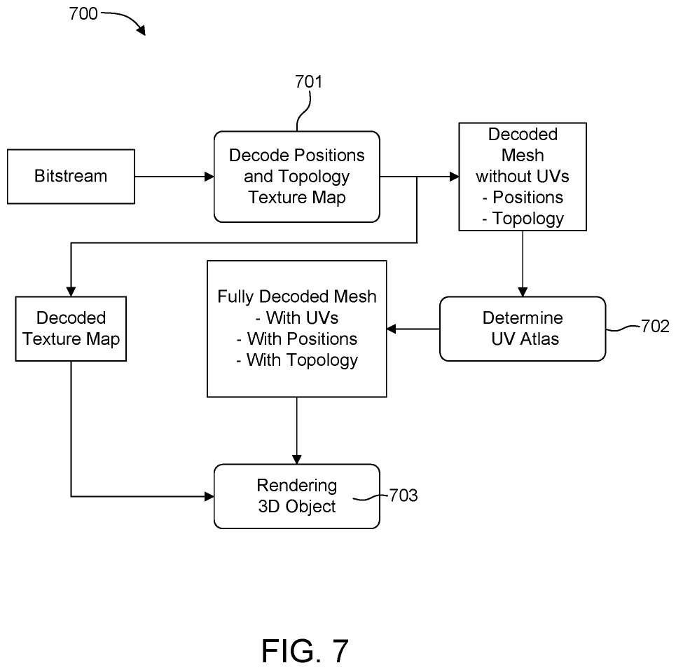

FIG. 7 illustrates an example of a method 700 for decoding a 3D object, according to another embodiment. At 701, positions and topology of the mesh are decoded from a bitstream, as well as the texture map. According to the principles provided herein, the bitstream does not contain any UV texture coordinates associated to the vertices of the mesh. At 702, the decoded mesh comprising the decoded positions and topology are used for determining the UV texture coordinates associated to each decoded vertex of the mesh. The UV texture coordinates are generated according to the same method that was used at the encoder. In some variants, metadata indicating a UV atlas generation method is decoded from the bitstream, as well as any useful parameters. A full decoded mesh is thus obtained, and a decoded texture map. At 703, the 3D object is rendered.

The encoding and decoding algorithms used to compress and decompress the mesh without texture coordinates can be of any sort. However, if the topology changes, for instance if the topology is lossy encoded, a mapping between the original mesh triangles and the coded/decoded triangles has to be provided, hence making it possible to determine the re-projection of the texture map at the encoding stage. This mapping can be a table that associates the destination triangle index with the source triangle index for each triangle of the coded/decoded mesh.

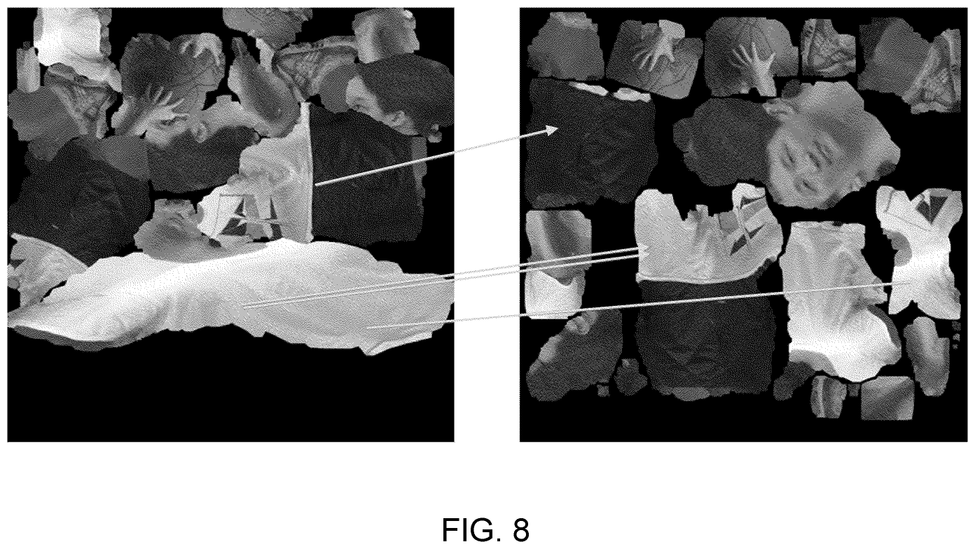

The texture map reprojection relies on the source and destination meshes' respective UV coordinates to produce a new texture map that match the newly generated UV atlas (the one of the destination mesh). FIG. 8 illustrates examples of an original texture map on the left and a reprojected texture map on the right using the newly generated UV atlas.

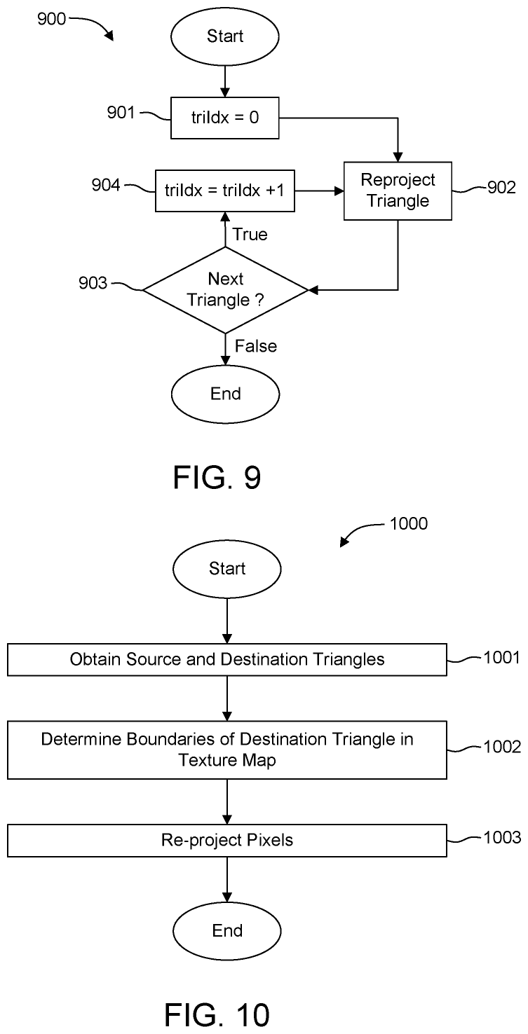

FIG. 9 illustrates an example of a method 900 for reprojecting the texture map, according to an embodiment. Some variables are described below for easier understanding.

### Notations:

In the following the ‘*’ character denotes the standard multiplication.

In the following the ‘.’ character denotes the dereference of a value of a field of values (e.g. vec.x accesses the x field of the vector vec).

### Input Parameters:

srcModel: the source mesh with original UVs (first texture coordinates)
dstModel: the destination mesh with its new UVs (second texture coordinates)
inputMap: a two-dimensional array of colors, the input texture map
outputMap: a two-dimensional array of colors, the reprojected texture map
useFaceMapping: a Boolean set to true if source and destination meshes are not identically indexed
modelFaceMapping: table that associates destination triangle index with source triangle index

### Variables:

srcV1, srcV2, srcV3: source triangle vertices; each vertex contains a UV 2D vector and a position 3D vector of real values,
dstV1, dstV2, dstV3: source triangle vertices; each vertex contains a UV 2D vector and a position 3D vector of real values,
scrTriIdx: source triangle index: an integer
uvMin: a vector of two components, each component is a real value
uvMax: a vector of two components, each component is a real value
intUvMin: a vector of two components, each component is an integer value
intUvMax: a vector of two components, each component is an integer value
dstUV: a vector of two components, each component is a real value
srcUV: a vector of two components, each component is a real value
bary: a vector of three components, each component is a real value
srcCol: a color (any representation is possible but must fit the one of the colors stored in inputMap and outputMap).

The method 900 loops over all the triangles of the decoded mesh and reproject (902) each triangle from the original texture map to the new texture map. For that, at 901, a variable triIdx indicating the index of a current triangle of the decoded mesh is initialized to 0. At 902, the current triangle is re-projected. A method for reprojecting the triangle is described below. At 903, it is checked whether all the triangles of the decoded mesh have been reprojected. If not, then the process passes to the next triangle at 904. Otherwise, the process ends.

FIG. 10 illustrates an example of a method 1000 for reprojecting a triangle, according to an embodiment. At 1001, the source (i.e original) and destination (i.e decoded) triangles are fetched, i.e. their vertices are retrieved from memory. At 1002, the bounding box of the decoded triangle in the new texture map is determined.

An example of source code for determining the bounding box of the decoded triangle is provided below:
   | // compute the UVs bounding box for the destination triangle
   | uvMin={MAX_REAL, MAX_REAL}
   | uvMax={−MAX_REAL, −MAX_REAL}
   | // with min and max functions working per component
   | uvMin=min(dstV3.uv, min(dstV2.uv, min(dstV1.uv, uvMin)))
   | uvMax=max(dstV3.uv, max(dstV2.uv, max(dstV1.uv, uvMax)))
   | // find the integer coordinates covered in the map
   | intUvMin={inputMap.width*uvMin.x, inputMap.width*uvMin.y}
   | intUvMax={inputMap.width*uvMax.x, inputMap.width*uvMax.y}
   | // with min and max functions working per component
   | intUvMin=max(intUvMin, {0, 0})
   | intUvMax=min(intUvMax, {inputMap.width−1, inputMap.width−1})

At 1003, pixels of the decoded are projected. That is, the pixels inside of the bounding box of the decoded triangle are parsed and each pixel belonging to the decoded triangle is assigned a color value obtained based on the source texture map.

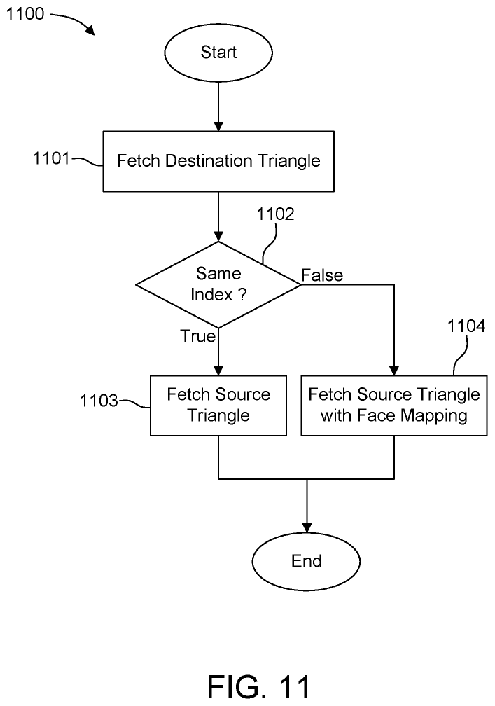

FIG. 11 illustrates an example of a method 1100 for fetching a decoded triangle and a corresponding source triangle, according to an embodiment. At 1101, vertices of the decoded triangle are obtained. At 1102, it is checked whether the source and decoded meshes are identically indexed. If this is the case, then the index of the current triangle of the decoded mesh is the same as the corresponding triangle in the source mesh. So, at 1103, the vertices of the source triangle are retrieved. Otherwise, at 1104, an index for the source triangle is obtained from the modelFaceMapping table using the index of the current triangle. The table modelFaceMapping associates the decoded triangle index with index of triangles in the source mesh. The table can be determined for instance when encoding the topology of the source mesh.

Since the modelFaceMapping table is only needed when obtaining the new texture map, and the new texture map is then encoded in the bitstream, there is no need to encode the modelFaceMapping table.

Then at 1104, vertices of the source triangle indexed by the obtained index are retrieved.

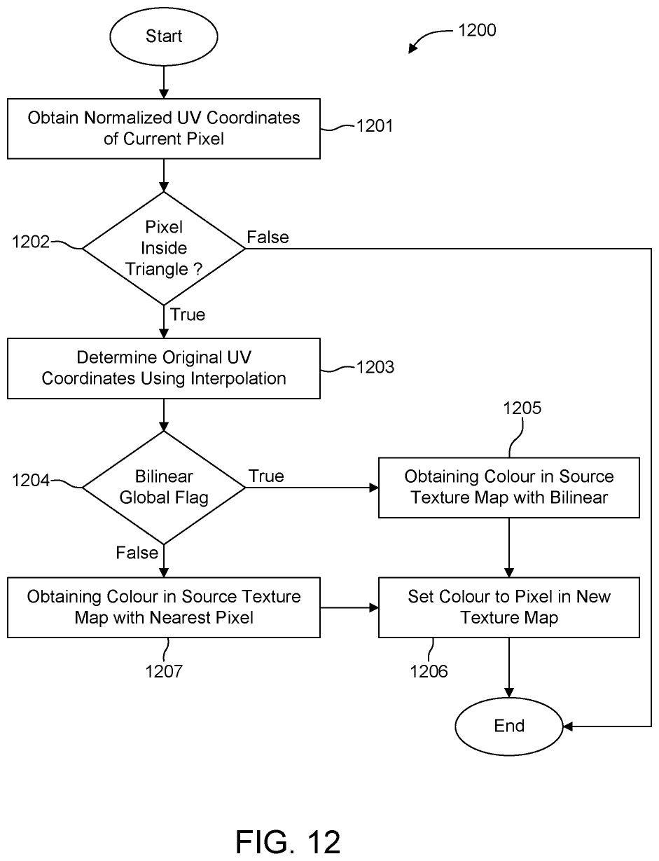

FIG. 12 illustrates an example of a method 1200 for reprojecting a pixel, according to an embodiment. Method 1200 can be used for instance at 1003 of method 1000. At 1201, normalized UV coordinates of a current parsed pixel of the decoded triangle bounding box determined at 1002 are obtained. For that, dstUV is initialized with the uv coordinate corresponding to the center of the pixel with coordinate (i,j) as dstUV={(0.5+i)/inputMap.width, (0.5+j)/inputMap.height};

At 1202, it is checked whether the current pixel is inside the decoded triangle. A function getBarycentric is used where it returns true if dstUV is inside the triangle made of (dstV1.uv, dstV2.uv, dstV3.uv), and false otherwise. The Boolean output is set to the variable inside=getBarycentric (dstUV, dstV1.uv, dstV2.uv, dstV3.uv, bary). The function computes the barycentric coordinates (u, v, w)˜res(x,y,z) for a point p with respect to a triangle (a, b, c). Example of source code for the function is given below:

```
bool getBarycentric(glm::vec2 p, glm::vec2 a, glm::vec2 b,
glm::vec2 c, glm::vec3& res)
{
  glm::vec2 v0 = b - a, v1 = c - a, v2 = p - a;
  float den = v0.x * v1.y - v1.x * v0.y;
  float u = (v2.x * v1.y - v1.x * v2.y) / den;
  float v = (v0.x * v2.y - v2.x * v0.y) / den;
  float w = 1.0f - u - v;
  res.x = u; res.y = v; res.z = w;
  if (0 <= u && u <= 1 && 0 <= v && v <= 1 && u + v <= 1)
    return true;
  else
    return false;
```

If the current pixel is inside the decoded triangle, at 1203 original UV texture coordinates are determined for the current pixel. For instance, interpolation is used using the original UV texture coordinates associated to the source triangle that corresponds to the decoded triangle. Example of source code for the function that computes the position of a point from triangle (v0, v1, v2) and barycentric coordinates (u, v) is given below:

inline void triangleInterpolation(const glm::vec3& v0, const
glm::vec3& v1, const glm::vec3& v2, float u, float v, glm::vec3& p)
{ p = v0 * (1.0f - u - v) + v1 * u + v2 * v;}

At 1204, it is checked which method to use for determining the color for the current pixel. If bilinear interpolation is used, then at 1205, the color is obtained from the source texture map using bilinear interpolation and the UV texture coordinates determined at 1203.

Otherwise, at 1207, the color is obtained from the source texture map using nearest pixel and the UV texture coordinates determined at 1203. At 1206, the determined color is assigned to the current pixel of the new texture map.

In the above method, several methods have been used for determining the color for a pixel in the source texture map. Other methods are possible, and/or only one method can be available.

Below, examples of syntax that can be used in any one of the embodiments for encoding/decoding a 3D object presented above is described.

For instance, a UV_generation information indicating an activation and/or a method used for reprojection can be signaled as follows:

| | | |
|---|---|---|
| UV_generation | OFF/[1]/[2]/[3] | 2 bits or more if additional |
| | Off means do not use | reprojection choices. |
| | the tool. | |

If UV_generation algorithm is [1], the following parameter relating to the method of reprojection can be signaled, other parameters non described here can also be signaled.

| | | |
|---|---|---|
| Quality_level | FAST or QUALITY | 1 bit |
| Nb_patches | sets the maximum number of charts to generate | 8 bits or |
| | | more |

If UV_generation algorithm is [2] the following parameter relating to the method can be signaled, as well as others non described herein;

| | | |
|---|---|---|
| Bijectivity | ON/OFF | 1 bit |

Embodiments of a method for encoding/decoding at least one 3D object represented as an animated textured mesh have been described above. These embodiments allow a more economic encoding of the texture coordinates, at a minor cost of metadata (i.e. few bytes of metadata versus potential megabytes of UV coordinates). The above embodiments can apply to static and dynamic mesh lossy encoding.

It can be noted that re-projection introduces a minor distortion which prevents from using the solution for lossless encoding.

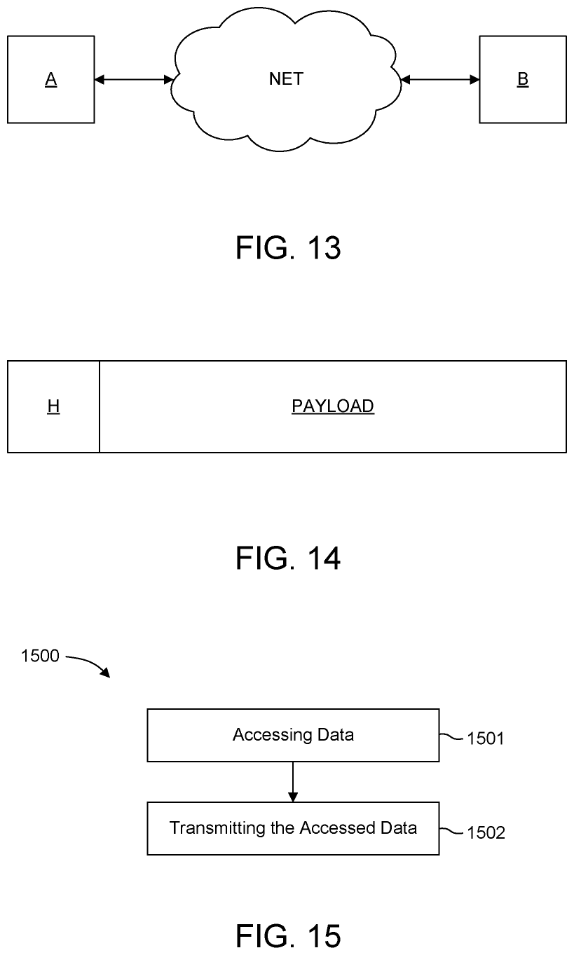

According to an example of the present principles, illustrated in FIG. 13, in a transmission context between two remote devices A and B over a communication network NET, the device A comprises a processor in relation with memory RAM and ROM which are configured to implement a method for encoding a 3D object according to an embodiment as described in relation with the FIGS. 1-12 and the device B comprises a processor in relation with memory RAM and ROM which are configured to implement a method for decoding a 3D object according to an embodiment as described in relation with FIGS. 1-12.

In accordance with an example, the network is a broadcast network, adapted to broadcast/transmit a signal from device A to decoding devices including the device B.

A signal, intended to be transmitted by the device A, carries at least one bitstream generated by the method for encoding a 3D object according to any one of the embodiments described above. According to an embodiment, the bitstream comprises coded video data representative of a topology of a mesh representative of a 3D object, of at least one face of the mesh, the at least one face comprising vertex positions, and coded data representative of an indication indicating a decoder to obtain texture coordinates for vertices of the at least one face based on the decoded topology and decoded vertex positions. In some embodiments, the bitstream also comprises metadata relating to a method used for generating the texture coordinates and/or coded data representative of texture data associated to the mesh, such as a texture map.

FIG. 14 shows an example of the syntax of such a signal transmitted over a packet-based transmission protocol. Each transmitted packet P comprises a header H and a payload PAYLOAD.

FIG. 15 illustrates an embodiment of a method (1500) for transmitting a signal according to any one of the embodiments described above. Such a method comprises accessing data (1501) comprising such a signal and transmitting the accessed data (1502) via a communication channel that may be implemented, for example, within a wired and/or a wireless medium. According to an embodiment, the method can be performed by the device 100 illustrated on FIG. 1 or device A from FIG. 13.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
generating, for at least one face of a mesh representative of a three dimensional (3D) object, the at least one face comprising vertex positions and first texture coordinates associated to the vertex positions in a first texture map, second texture coordinates in a second texture map from decoded vertices positions of the at least one face and decoded topology of the mesh,
obtaining the second texture map from the first texture map based on the first texture coordinates and on the second texture coordinates,
encoding the second texture map, and
encoding an indication of a method used for generating the second texture coordinates.

2. An apparatus, comprising one or more processors, wherein said one or more processors are configured to:
generate, for at least one face of a mesh representative of a three dimensional (3D) object, the at least one face comprising vertex positions and first texture coordinates associated to the vertex positions in a first texture map, second texture coordinates in a second texture map from decoded vertices positions of the at least one face and decoded topology of the mesh,
obtain the second texture map from the first texture map based on the first texture coordinates and on the second texture coordinates,
encode the second texture map, and
encode an indication of a method used for generating the second texture coordinates.

3. The method of claim 1, further comprising encoding the topology of the mesh and the at least one face of the mesh, providing a coded mesh.

4. The method of claim 1, wherein generating the second texture coordinates comprises generating the second texture coordinates using the decoded vertices positions.

5. The method of claim 1, wherein obtaining a second texture map from the first texture map based on the first texture coordinates and on the second texture coordinates comprises re-projecting the first texture map onto the second texture map using the first texture coordinates and the second texture coordinates.

6. The method of claim 1, further comprising encoding metadata relating to obtaining the second texture map.

7. The method of claim 3, wherein re-projecting the first texture map onto the second texture map using the first texture coordinates and the second texture coordinates comprises identifying for at least one decoded face of the coded mesh a corresponding face in the mesh before encoding.

8. A method, comprising:
decoding a topology of a mesh representative of a three dimensional (3D) object, and at least one face of the mesh, the at least one face comprising vertex positions,
decoding an indication of a method used for generating texture coordinates, and
generating the texture coordinates for vertices of the at least one face based on the decoded topology and decoded vertex positions and based on the indication.

9. An apparatus comprising one or more processors configured to:
decode a topology of a mesh representative of a three dimensional (3D) object, and at least one face of the mesh, the at least one face comprising vertex positions,
decode an indication of a method used for generating texture coordinates, and
generate the texture coordinates for vertices of the at least one face based on the decoded topology and decoded vertex positions and based on the indication.

10. The method of claim 8, further comprising:
decoding a texture map representative of texture data associated to the mesh, and
rendering the 3D object using at least the generated texture coordinates and the decoded texture map.

11. The method of claim 8, wherein topology and vertices positions are decoded from a bitstream.

12. (canceled)

13. The method of claim 8, further comprising decoding an indication indicating to obtain texture coordinates for vertices of the at least one face based on the decoded topology and decoded vertex positions.

14. (canceled)

15. A computer readable storage medium having stored thereon instructions for causing one or more processors to perform the method of claim 8.

16. The apparatus according to claim 9 comprising
at least one of (i) an antenna configured to receive a signal, the signal including data representative of at least one part of a 3D object, (ii) a band limiter configured to limit the received signal to a band of frequencies that includes the data representative of the at least one part of the 3D object, or (iii) a display configured to display the at least one part of the 3D object.

17. (canceled)

18. A computer readable storage medium having a storage thereon a bitstream comprising:
coded video data representative of a topology of a mesh, of at least one face of the mesh, the at least one face comprising vertex positions,
coded data representative of an indication indicating a decoder to the texture coordinates for vertices of the at least one face based on decoded topology and decoded vertex positions, and
metadata relating to a method used for generating the texture coordinates.

19-22. (canceled)

23. The apparatus of claim 9, wherein the one or more processors are further configured to:
decode a texture map representative of texture data associated to the mesh, and
render the 3D object using at least the generated texture coordinates and the decoded texture map.

24. The apparatus of claim 9, wherein topology and vertices positions are decoded from a bitstream.

25. The apparatus of claim 9, wherein the one or more processors are further configured to decode an indication indicating to obtain texture coordinates for vertices of the at least one face based on the decoded topology and decoded vertex positions.

26. The apparatus of claim 2, wherein the one or more processors being configured to obtain a second texture map from the first texture map based on the first texture coordinates and on the second texture coordinates comprises the one or more processors being configured to re-project the first texture map onto the second texture map using the first texture coordinates and the second texture coordinates.

27. The apparatus of claim 2, wherein the one or more processors are further configured to encode metadata relating to obtaining the second texture map.
